(19) United States
(12) Patent Application Publication
(10) Pub. No.: US 2011/0203428 A1
(43) Pub. Date: Aug. 25, 2011

(54) Siding cutting table

(76) Inventor: Samuel A. Zimmerman, Selinsgrove, PA (US)

(21) Appl. No.: 12/928,380

(22) Filed: Dec. 10, 2010

Related U.S. Application Data
(60) Provisional application No. 61/283,916, filed on Dec. 10, 2009.

(51) Int. Cl. B25H 1/04; B26D 3/00

(52) U.S. Cl. 83/13; 269/303; 269/291

(57) ABSTRACT

The present invention provides a Siding Cutting Table, comprising a work surface specially designed for cutting aluminum or vinyl siding, as well as other construction materials such as wood and similar. Fabricated of a durable, heavy duty aluminum material, the Siding Cutting Table is generally rectangular in shape, measuring approximately nine feet eight inches in overall length, sixteen inches in width, and one and three-quarter inches in depth. A tri-sectioned unit, the product would consist of an “A” section with an enlarged surface on the left, a smaller “C” section in the center, and a similarly small “B” section on the right. These sections are separated by “K” pieces, or removable slots. The table also comes equipped with a table stabilizer beam located underneath the unit, as well as foldable legs that ensure easy transport and storage.

### CLAIM OF PRIORITY

This patent application claims priority under 35 USC 119(e) (1) from U.S. Provisional Patent Application Ser. No. 61/283,916 filed Dec. 10, 2009, of common inventorship herewith entitled, “Siding Cutting Table.”

### FIELD OF THE INVENTION

The present invention pertains to the field of construction work tables, and more specifically to the field of home siding cutting tables.

### BACKGROUND OF THE INVENTION

The prior art has put forth several designs for home siding cutting tables. Among these are:

U.S. Pat. No. 4,327,619 to John J. McNamee Jr. describes a cutting table for cutting house siding which is provided for use with a power saw held on a guide rotated to make miter cuts and hold the sheet on the table and against the rail.

U.S. Pat. No. 5,954,106 to Jin Lai Huang describes a work bench which includes a table secured on top of a base and having a pair of parallel grooves. Two pair of sprockets are rotatably secured to the table and extended inward of the grooves. Two endless chains are engaged with the sprockets and each has a portion slidably engaged in the grooves. A guide is secured to the chains and moveable in concert with the chains.

U.S. Pat. No. 6,705,192 to J. Richard Logan describes a collapsible table assembly having improved portability. A mechanism interconnects the table and supporting legs for moving the legs between a diverging supporting position, a folding position, and a storage position.

U.S. Pat. No. 7,316,250 to Frank Michael John Kent describes a worktable system comprising a supporting structure and fastening means supported by said supporting structure for fastening a workpiece, characterized in that said fastening means are adapted to provide directional guidance for movement of a tool, in particular a power tool, to machine the work piece while it is fastened by said fastening means.

None of these prior art references describe the present invention.

### SUMMARY OF THE INVENTION

It is an object of the present invention to provide a work surface specially designed for cutting aluminum or vinyl siding, as well as other construction materials such as wood and similar.

### BRIEF DESCRIPTION OF THE DRAWINGS

FIG. 1 is an exploded view of the device of the present invention.

FIG. 2 is a close-up elevational view of a portion of the apparatus where the cut is made.

FIG. 3 is a schematic diagram of Pan A.

FIG. 4 is a schematic diagram of Pan B.

FIG. 5 is a schematic diagram of Pan C.

FIG. 6 is a schematic diagram of Pan D.

FIG. 7 is a schematic diagram of Pan E.

FIG. 8 is a schematic diagram of saw guide F.

FIG. 9 is a schematic diagram of section G.

FIG. 10 is a schematic diagram of section K.

FIG. 11 shows the components and their letter designations and how they fit together.

### DETAILED DESCRIPTION OF THE INVENTION

Inventions are always a product of vision and creativity, whether world-changing inventions like cars or computers, or everyday conveniences like pump hairsprays, cordless tools, or resealable soda bottles. Some inventions present us with a product that is entirely new, like a cell phone; and before long, such an invention literally changes the way we live. Other inventions combine two already-existing tools or products into one, a snow-scraper and brush, for example, thus reducing the clutter in our lives, and making, in this example, our daily winter chores a little easier. Some inventions deal with common problems, as, for example, roll-on deodorants deal with body odors; others, and again the cell phone is a good example, bring us so much convenience that we didn't know we needed them until they came into being. Many, if not most, inventions consist of relatively small but highly effective improvements of existing products or technologies. Inventions come in so many categories that counting them all would be difficult because you never know what might be invented today. Sometimes necessity, sometimes creativity, is the mother of invention. All we can say for certain is that somewhere, someone is even now combining their own vision, imagination, and creativity to create something that will improve, or even revolutionize, our lives.

Most inventions fill a relatively small need or perform a specialized, limited function. If that need is shared by a sufficient number of consumers, the invention may have a great potential for success. Consider, for example, aluminum and vinyl siding. Aluminum and vinyl siding first began appearing on homes in the early 1960s. Aluminum is more expensive than vinyl but it is readily available in a variety of colors and aluminum generally increases the value of your house more than vinyl. It is advertised as low-maintenance and comes in two basic types. One gives the appearance of wide or narrow boarding and offers a range of colors which have been applied at the factory. Since it has a greater range of styles, colors and textures, it can be easily adapted to most any architectural styles. The main advantages of aluminum siding include its longevity and low maintenance as it is finished with coatings that are formulated for toughness and long-term durability.

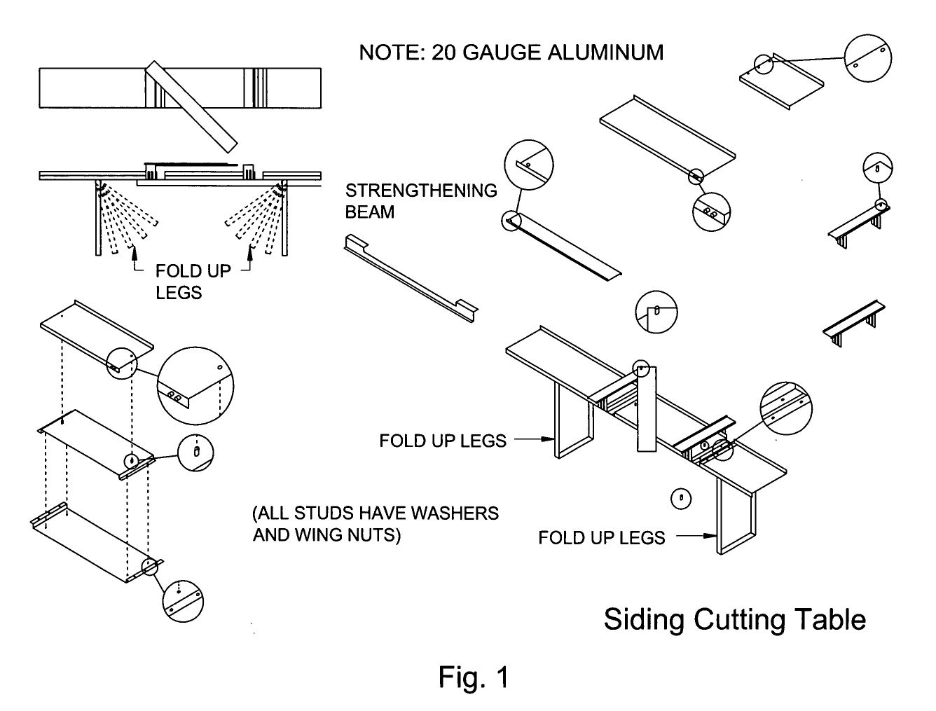

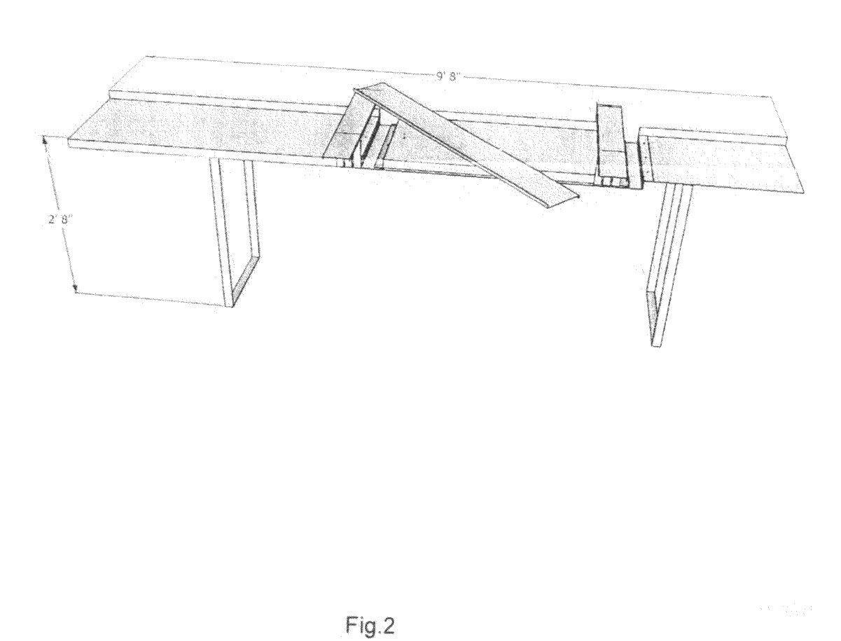

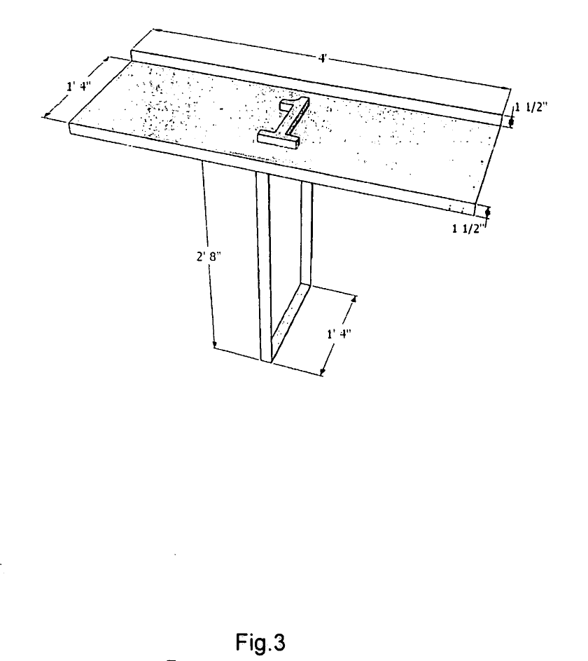

The present invention, hereinafter referred as the Siding Cutting Table, is essentially just that, a work surface specially designed for cutting aluminum or vinyl siding, as well as other construction materials such as wood and similar. This invention offers professionals and do-it-yourselfers a new tool that facilitates time savings by eliminating hand cutting, as well as easier angle cuts without the aid of another person. Please refer to FIG. 1. Fabricated of a durable, heavy duty aluminum material, the Siding Cutting Table is generally rectangular in shape, measuring approximately nine feet eight inches in overall length, sixteen inches in width, and one and three-quarter inches in depth. A tri-sectioned unit, the product would consist of an “A” section with an enlarged surface on the left, a smaller “C” section in the center, and a similarly small “B” section on the right. These sections are separated by “K” pieces, or removable slots. The table also comes equipped with a table stabilizer beam located underneath the unit, as well as foldable legs that ensure easy transport and storage.

An example of how the Siding Cutting Table works is when the user separates the “A” section from the “C” section via the left “K” piece, then uses the “K” piece as a saw guide to facilitate angled cuts of the material. Conversely, the “C” section's right “K” piece is separated for straight, ninety degree cuts. Fully developed and put to use, the Siding Cutting Table revolutionizes the construction industry as it is known. In addition to making siding projects much easier and less time consuming, this versatile product is also employed with other building materials, such as wood. Creatively designed with simplicity as its core application, the Siding Cutting Table is well received by professional tradespeople, in addition to those who choose to complete their own building tasks.

Three main pans make up the table top. The overall length of the three pans measures approximately nine feet, eight inches. The length of pan A is approximately forty-eight inches, and the width is approximately sixteen inches, and pan A also comprises a lip of approximately one and a half inches along its length. Pan B is approximately forty-four inches in length, and Pan C is approximately twenty-four inches in length. Pan E sits on top of Pan D. Pan D and Pan sits on top of and connect with Pan B. To enable ninety degree straight cuts using saw guide F which is slotted for height adjustment to accommodate the differing heights of the materials to be cut. When cutting angles other than ninety degrees, Pan D and Pan E and straight cut guide F lift off of Pan B. After lifting off Pan D, Pan E and guide F, fasten the saw guide F to Pan A, which is slotted on the right side for easy installation of the guide F to cut angles.

All pans have a lip of approximately one and a half inches on both the top and the bottom. The lip on the top length bends up. The lip on the bottom length bends down. In an alternative embodiment the top length of the table can include hatch marks to easily indicate a measurement of the material being cut. These hatch marks are in one inch and fractions of inch spaces, and numbered zero to seventy-two going from right to left (facing the table) and zero to forty-eight going from left to right starting at the place where the cut is made.

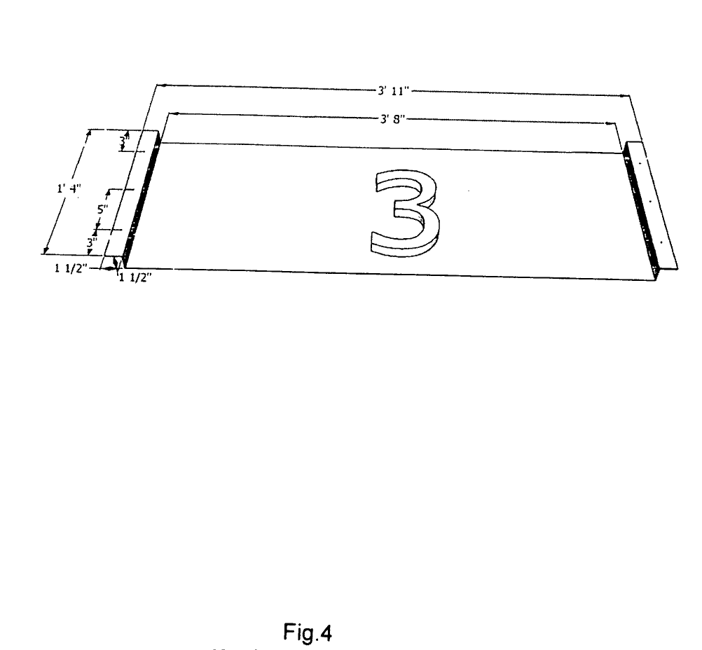

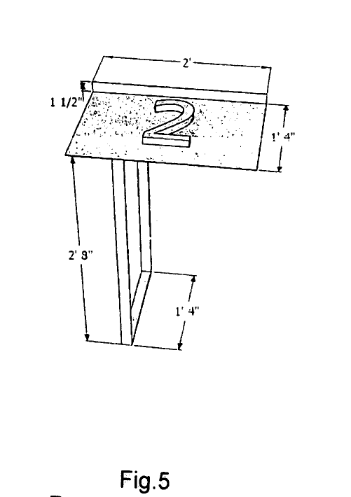

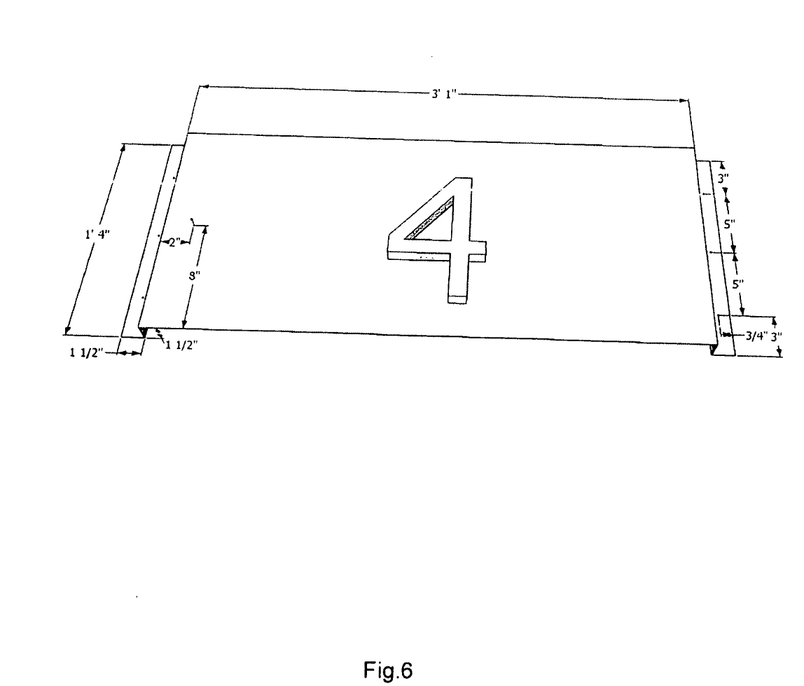

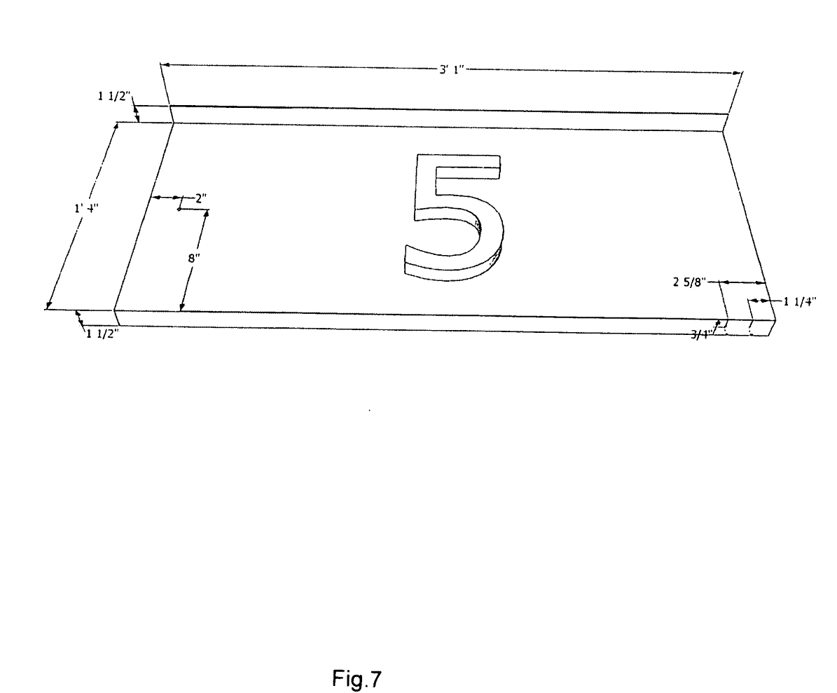

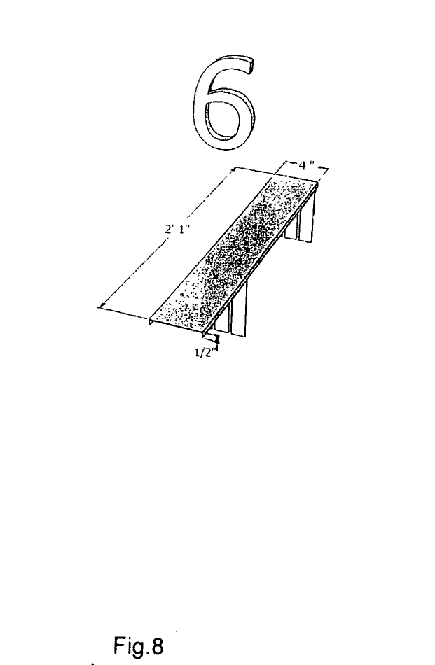

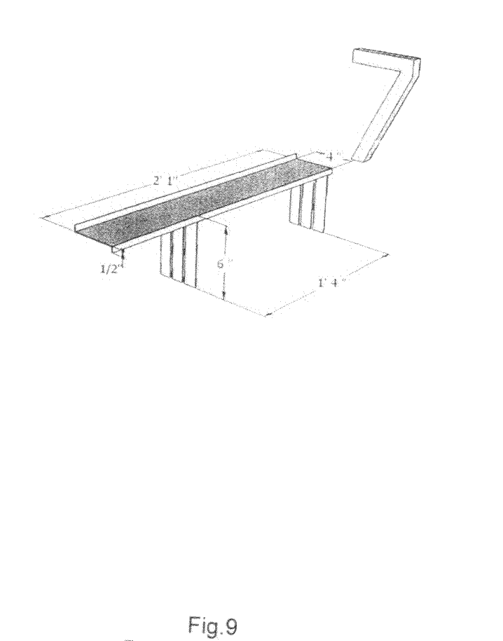

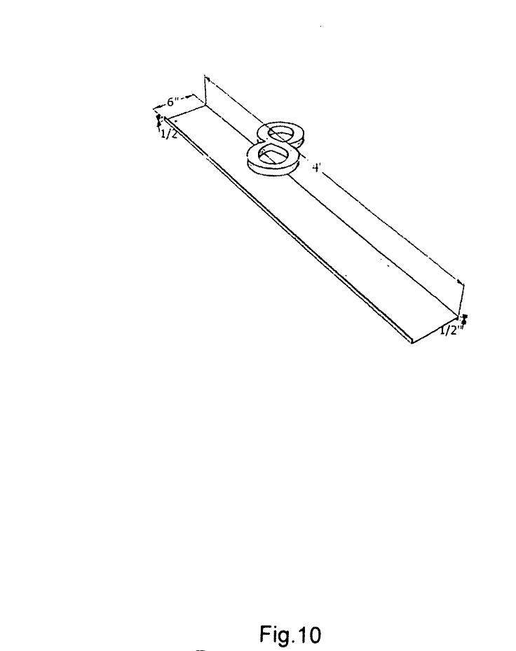

FIG. 4 shows a drop beam along the length of the table which adds strength and stability to the table and enables cuts to be made in materials without cutting into the table.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. Siding cutting table, comprising a table top comprising three pans wherein:
the first pan is Pan A and is essentially rectangular having a length of approximately forty-eight inches and a width of approximately sixteen inches;
the second pan is Pan B and is essentially rectangular in shape having a length of approximately forty-four inches, further comprising Pan E which sits on top of Pan D and wherein Pan D sits on top of and connects with Pan B;
the third pan is Pan C and is essentially rectangular in shape and is approximately twenty-four inches in length;
and wherein Pan A, Pan B and Pan C are further comprising a lip of approximately one and one half inches which lip runs along the back length and is bent up at an angle of approximately ninety degrees from the pan and a lip which runs along the front length and is bent down at an angle of approximately ninety degrees from the pan;
and further comprising two essentially rectangular legs upon which Pan A and Pan C rest, wherein the legs join Pan A and Pan C at approximately ninety degree angles and are approximately thirty-two inches in height and approximately sixteen inches in width.

2. The siding cutting table of claim 1 further comprising a saw guide which is slotted for height adjustment to accommodate the differing heights of the materials to be cut.

3. A method of cutting siding material at an angle other than ninety degrees using the table of claim 2 comprising removing Pan D and Pan E and straight cut saw guide F from Pan B, fastening saw guide F to Pan A at the desired angle, wherein Pan A is slotted on the right side for easy installation of the guide F to cut angles; cutting siding material.
